(19) United States
(12) Patent Application Publication
(10) Pub. No.: US 2013/0085796 A1
(43) Pub. Date: Apr. 4, 2013

(54) Method and Apparatus for Work Management

(71) Applicant: FRANK RUFFOLO, South Barrington, IL (US)

(72) Inventor: FRANK RUFFOLO, South Barrington, IL (US)

(21) Appl. No.: 13/251,485

(22) Filed: Oct. 3, 2011

(51) Int. Cl. G06Q 10/06

(52) U.S. Cl. 705/7.18

(57) ABSTRACT

An apparatus, system and/or method that incorporates teachings of the present disclosure may include, for example, presenting scheduling options on a display device where the scheduling options are determined based on scheduling information that comprises employment schedule data for other users that are associated with a user requesting the scheduling, receiving a scheduling selection from among the scheduling options that is inputted by the user via a user interface and providing the scheduling selection for evaluation. Other embodiments are disclosed.

### FIELD OF THE DISCLOSURE

The present disclosure relates generally to work management and a method and apparatus for work management.

### BACKGROUND

Management of employees typically requires interaction with the employees to fulfill a number of different desires of the employees. In centralized working environments, such as where each of the employees are located at the same facility with supervisors and/or human resources personnel, the interaction can more readily be implemented. However, such interaction can be difficult for other situations, such as in distributed work environments, for example large corporations with many locations, including satellite locations that include a limited number of employees.

### BRIEF DESCRIPTION OF THE DRAWINGS

The exemplary embodiments may be understood by reference to the following description taken in conjunction with the accompanying drawings, in the several figures in which like reference numerals identify like elements, and in which:

FIG. 1 is an illustrative embodiment of an electronic terminal in accordance with one or more of the exemplary embodiments.

FIG. 2 is a block diagram of the electronic terminal illustrated in FIG. 1.

FIG. 3 is an illustrative embodiment of a communication system in accordance with one or more of the exemplary embodiments and in which the electronic terminal of FIG. 1 can operate.

FIG. 4 is an illustrative embodiment of another communication system in accordance with one or more of the exemplary embodiments and in which the electronic terminal of FIG. 1 can operate.

FIG. 5 is an illustrative embodiment of the central processing server array of the communication system illustrated in FIG. 4.

FIG. 6 depicts an illustrative embodiment of a method operating in portions of one or more of the devices and systems of FIGS. 1-5.

FIG. 7 depicts an illustrative embodiment of a method operating in portions of one or more of the devices and systems of FIGS. 1-5.

FIG. 8 depicts an illustrative embodiment of a method operating in portions of one or more of the devices and systems of FIGS. 1-5.

FIG. 9 depicts an illustrative embodiment of a method operating in portions of one or more of the devices and systems of FIGS. 1-5.

FIG. 10 depicts an illustrative embodiment of a communication device utilized in the communication systems of FIGS. 3-4 and the methods of FIGS. 6-9.

FIG. 11 is a diagrammatic representation of a machine in the form of a computer system within which a set of instructions, when executed, may cause the machine to perform any one or more of the methods disclosed herein.

### DETAILED DESCRIPTION

One or more of the exemplary embodiments describe an apparatus and method for adjusting the schedules of employees through use of an electronic terminal that can be located at the facility of the employees. In one or more embodiments, the electronic terminal can communicate remotely to obtain scheduling approval, such as from a human resources system and/or from supervisors. In one or more embodiments, messages can be transmitted from the electronic terminal to facilitate the scheduling approval process, including messages sent to a requesting employee and/or messages sent to an associated supervisor. In one or more embodiments, the scheduling adjustments can be for paid time off days, which can be tracked by the electronic terminal. In one or more embodiments, the approval process can include voice and/or video conferences between the employee and the supervisor, which can utilize the electronic terminal as one of the end user devices for the conference. In one or more embodiments, the approval process can include an analysis based on scheduling information such as conflicts with other employee schedules, skill sets of available employees, workloads and so forth. In one or more embodiments, alternative schedule options can be generated based on real-time data.

One or more of the exemplary embodiments can include an apparatus having a memory, a user interface, a display device and a controller circuit. The controller circuit can be coupled to the memory, the user interface and the display device. The controller circuit can be programmed to present a self-service graphical user interface (GUI) on the display device and to receive a GUI selection from the self-service GUI that is inputted via the user interface. The controller circuit can be programmed to obtain scheduling options responsive to the GUI selection being a request for scheduling for a user, where the scheduling options are determined based on scheduling information, and where the scheduling information comprises employment schedule data for other users that are associated with the user. The controller circuit can be programmed to present the scheduling options on the display device, to receive a scheduling selection from among the scheduling options that is inputted by the user via the user interface, and to provide the scheduling selection to a remote server for evaluation. The controller circuit can be programmed to receive a human resources approval associated with the scheduling selection from the remote server and to provide a printed confirmation of the human resources approval.

One or more of the exemplary embodiments can include a non-transitory computer-readable storage medium having computer instructions that, when executed by at least one processor, cause the at least one processor to receive a request for scheduling of a user via a user interface of an electronic terminal, to obtain scheduling options responsive to the received request where the scheduling options are determined based on scheduling information and where the scheduling information comprises employment schedule data for other users that are associated with the user, and to present the scheduling options on a display device of the electronic terminal. The computer instructions that, when executed by at least one processor, cause the at least one processor to receive a scheduling selection from among the scheduling options that is inputted by the user via the user interface, to determine an availability of a supervisor associated with the user, and to initiate a video conference for obtaining a scheduling determination when the supervisor is determined to be available, where the video conference utilizes the user interface and the display device of the electronic terminal.

One or more of the exemplary embodiments can include a server having a memory and a controller circuit coupled to the memory, where the controller circuit is programmed to communicate over a network with a group of electronic terminals at remote locations and to receive a request for scheduling from an electronic terminal of the group of electronic terminals, where the request was generated at the electronic terminal via a user input of a user. The controller circuit is programmed to access scheduling information associated with the user where the scheduling information comprises employment schedule data for other users that are associated with the user, to determine scheduling options based on the scheduling information, and to provide the scheduling options to the electronic terminal for presentation to the user. The controller circuit is programmed to receive a scheduling selection from among the scheduling options where the scheduling selection was generated at the electronic terminal via another user input of the user and to adjust the scheduling information based on the scheduling selection prior to receiving a scheduling determination of a supervisor associated with the user.

One or more of the exemplary embodiments can be a method including receiving a request for scheduling of a first user via a user interface of an electronic terminal, obtaining scheduling options from a remote server responsive to the received request where the scheduling options are determined based on scheduling information and where the scheduling information comprises employment schedule data for other users that are associated with the first user. The method can include presenting the scheduling options on a display device of the electronic terminal, receiving a scheduling selection from among the scheduling options that is inputted by the first user via the user interface, and monitoring for access to the electronic terminal by a second user of the other users. The method can include providing a message on the display device to the second user responsive to the second user accessing the electronic terminal, where the message is based on the scheduling selection inputted by the first user, and where the message represents a query to exchange a portion of schedules associated with the first and second users.

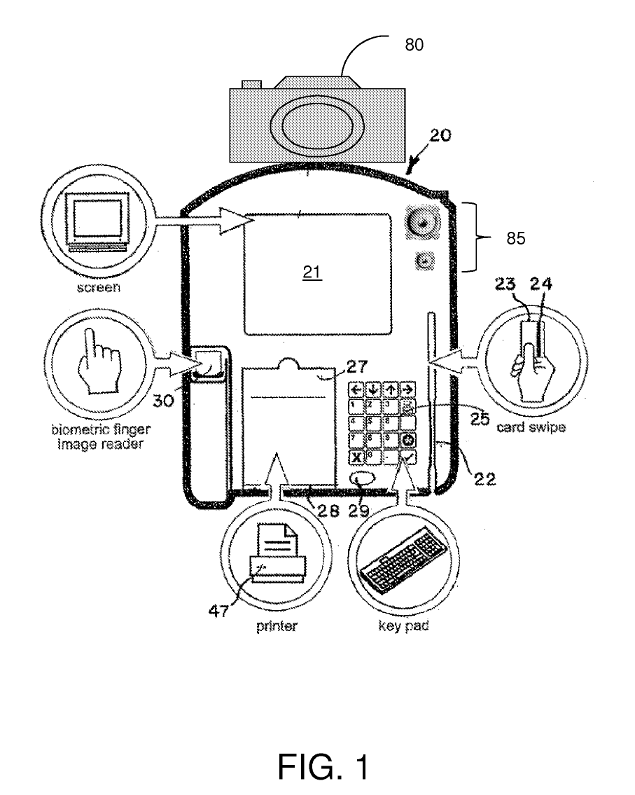

Referring to the Figures, and particularly to FIG. 1, an electronic terminal is illustrated and generally indicted by reference numeral 20. Electronic terminal 20 can include ATM, payroll and/or work management capability. Terminal 20 can be a processing device that can be installed or otherwise provided at a desired location, such as at one or more remote facilities of an employer, customer and so forth. The terminal 20 can be installed via hardwire coupling of the processor to communication and/or power lines of the facility. As an example, the terminal 20 can be a relatively light-weight apparatus that can be delivered to the desired location and then installed through coupling various communication and power lines. Other installation steps can also be taken, such as securing the terminal 20 to infrastructure at the particular location.

Terminal 20 can include a display screen or device 21 for displaying various selectable and non-selectable content, including scheduling information, options, commands, work assignments, messages or the like. The source of the content can vary and can include the memory of the terminal 20 and/or remote sources. Display 21 can be of various types, such as a liquid crystal display (LCD) type. The terminal 21 can be positioned at various locations, including areas that employees utilize to check-in or check-out of work, such as at the employer's facilities or at the customer's facilities in those instances where the employees work at the customer's facilities (e.g., a construction site or janitorial or cleaning staff).

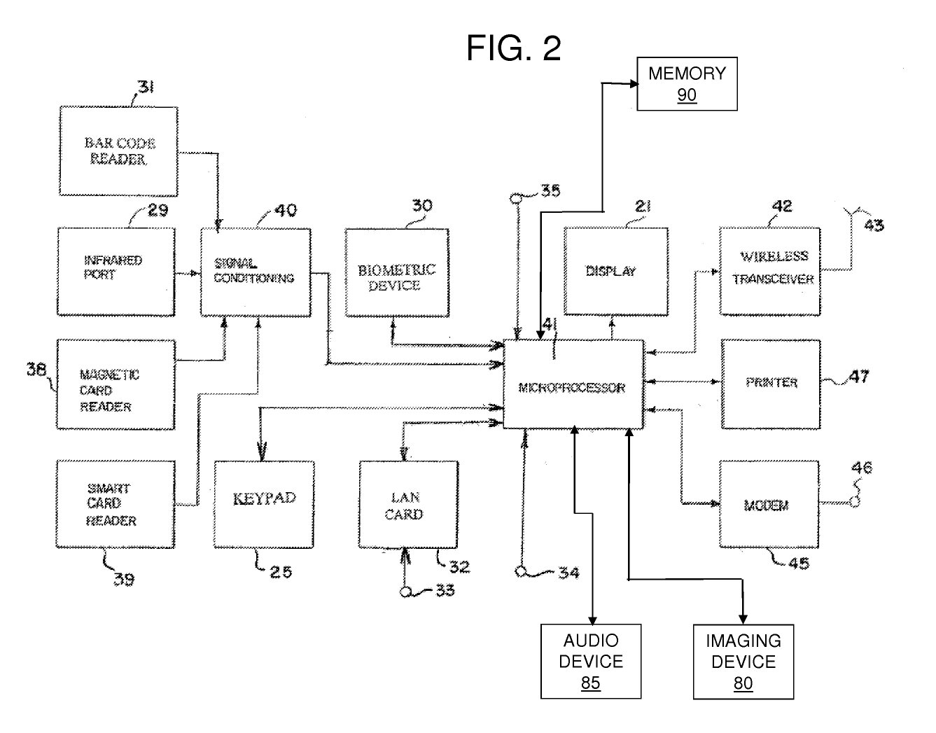

Referring additionally to FIG. 2, terminal 20 can include a reader device, such as card reader 38. In one embodiment, the card reader 38 can be a magnetic card reader including a slot 22 for reading a card 23, such as a bank card or other card that stores information thereon. Terminal 20 can also include a keyboard or keypad 25, a printer port 28 and a biometric device 30.

Card reader 38 can read the information contained on a magnetic stripe 24 of the bankcard 23, such as a bank account number. For example, card 23 can be a bankcard issued by a bank and the magnetic stripe can have a unique identifying number encoded therein which corresponds to one or more accounts at the bank. Terminal 20 can also read information from smart cards utilizing smart card reader 39. In one embodiment, bankcard 23 and/or a smartcard can be used with the terminal 20 as an ATM, payroll and work management card as described more fully in U.S. Patent Application No. 20080041942, U.S. Pat. No. 7,229,013 and U.S. Pat. No. 6,764,013, the disclosures of each of which are hereby incorporated by reference. It should be understood that one or more of the components and/or method steps described with respect to U.S. Patent Application No. 20080041942, U.S. Pat. No. 7,229,013 and U.S. Pat. No. 6,764,013 can be used with, or in place of, one or more of the components and/or method steps described with respect to the exemplary embodiments in the present application.

Keypad 25 can include a plurality of keys for entering alpha-numeric information, for scrolling through the information displayed on display 26, for accessing a prior page or the next page for entering selected information, and the like. In addition to the keypad 25, or in place thereof, the display 21 can be a touch sensitive screen that can function similarly to the keypad to enable the entry of alpha-numeric information as well as allow for selection and scrolling through various information, including selectable options. In one embodiment, the touch-sensitive screen can present the key pad in a select area of the screen (e.g., so as not to block selectable options or an ongoing video conference) and/or can present the keypad in a semi-transparent fashion so that other content can be seen simultaneously with the keypad.

In one embodiment, the keypad can include one or more hotkeys (e.g., a key with a circular indicia) for starting desired functions such as reading a fingerprint on biometric device 30, a key with a printer symbol for printing the current screen appearing on display 21, a star button to continue a desired function, a key with a check mark for approving or responding to specific inquiries or options, and/or a key with an “X” indicia for exiting the present function or for deleting information entered into terminal 20.

Printer port 28 can include a printer 47 disposed behind an access door 27 and space for provisioning the terminal 20 with a source of paper (e.g., a roll of paper located behind the access door). In one embodiment, when the terminal 20 is instructed to print, the printed paper from a roll can be dispensed through the printer port 28 such that the user may tear it off against the forward edge of the port. As an example, an authenticated employee may obtain a print-out of desired information associated with the user, such as a human resources approval of a scheduling request, a supervisor approval of a scheduling request, a receipt for cashing in a Paid Time Off (PTO) day, confirmation of a PTO day rolled to another fiscal period and/or a payroll stub relating to the most recent pay period including details about gross pay, deductions and net pay. It should be understood that a PTO day can include a whole or portion of an entire work day and can include various types of PTO days, including vacation days, administrative paid leave, personal days, sick days, and so forth.

Other types of printed information obtained from terminal 20 may include current work assignments and/or locations, recent activity and balances in bank accounts related to the unique number of the bankcard, and the like. The results of work quality audits may also be made available for printing. In one embodiment, a supervisor can obtain a printed copy of scheduling information (e.g., schedules of other employees, work load for a user requesting a schedule adjustment, work load for the user's department or affiliated employees, predicted work production based on a scheduling request, alternative scheduling for the user and/or other information associated with the user or associated with co-workers of the user).

Terminal 20 can include a biometric device 30 for sensing or otherwise obtaining biometric information from a user seeking access to the terminal in order to authenticate the identity of the user. For example, the biometric device 30 can be a fingerprint reader and comparator (hereinafter fingerprint reader), although other biometric data can also be utilized, including voice recognition, facial scans, eye scans, and so forth. Due to the unique characteristics of human fingerprints, the fingerprint reader 30 may be used as an initial or primary form of employee identification and authentication, or to supplement the card reader 22 in its reading of the bankcard 23 (or other card storing employee-related information). The fingerprint reader 30 enables access to the terminal even though a user may forget or lose their bankcard.

The terminal 20 can also include an infrared communications port 29 to communicate with other devices that also utilize infrared communication means. For example, a supervisor of employees or a customer of employment services may have information about new or current work assignments, such as stored on a mobile communication device (e.g., a Personal Digital Assistance (PDA) or a smart phone) which can transfer the information to the terminal 20 via the infrared port. The terminal 20 can also be capable of utilizing other modes of communication, including wired and wireless communication, that can be used with mobile or fixed communication devices, including via the wireless transceiver 42 (which can be a multi-mode component capable of communication utilizing any number of different communication protocols either sequentially or simultaneously) shown in FIG. 2.

Terminal 20 can include an imaging device 80 which is integrally formed with the terminal and/or coupled thereto (e.g., through tethered or wireless communication). In one embodiment, the imaging device 80 can be retrofitted (e.g., via tethering and/or wireless communication) onto already existing terminals 20 that are in use at facilities. Imaging device 80 can capture still and/or moving images of an individual utilizing the terminal 20. The particular components and techniques utilized in imaging device 80 for capturing the images can vary and can include utilizing a digital camera.

Terminal 20 can include an audio interface 85 which is integrally formed with the terminal or coupled thereto (e.g., through tethered or wireless communication). Audio interface 85 can include a microphone and speakers for capturing and presenting audio signals, such as the speech of an individual utilizing the terminal 20. The particular components and techniques utilized in audio interface 85 for capturing and presenting the audio signals can vary.

Terminal 20 can include a bar code reader 31 which may be used to read the bar codes on supplies and/or products associated with the work environment of the user of the terminal. Thus, the inventory of supplies and/or products may be tracked. The bar code reader 31 can be of a wired and/or wireless type.

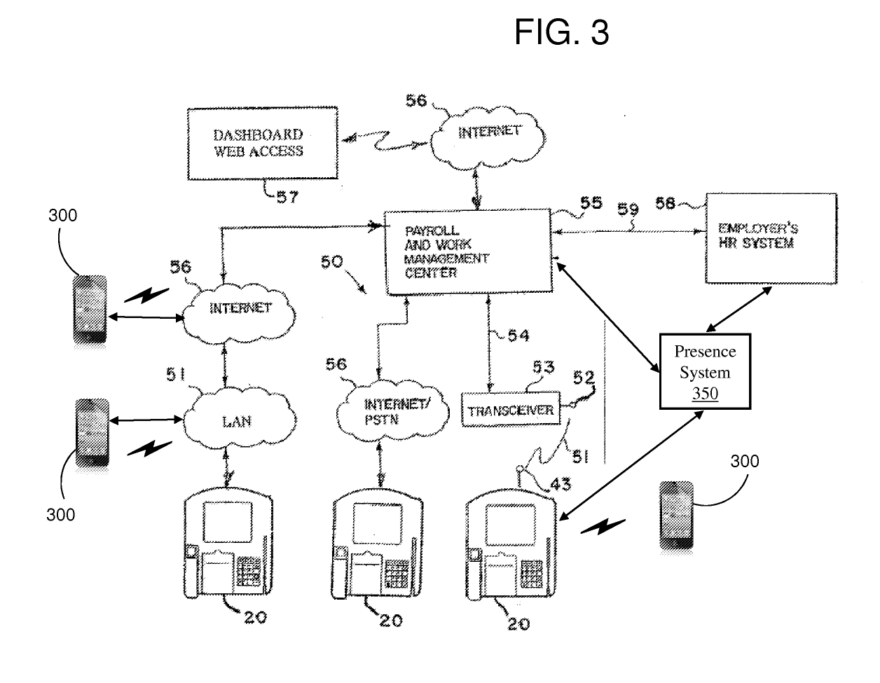

Information signals from the magnetic card reader 38, the smartcard reader 39, the bar code reader 31, the infrared port 35, the imaging device 80 and/or the audio interface 85 can be conditioned by signal conditioning circuitry 40 to provide input signals that are compatible with input terminals of a microprocessor 41 of the terminal 20. The microprocessor 41 can include or otherwise be coupled with a memory 90 for storage of information therein. The biometric device 30, the imaging device 80 and/or the audio interface 85 may in one embodiment interface directly with the microprocessor 41. A Local Area Network (LAN) card 32 can also interface with the microprocessor 41 to provide further connectivity in the system 50 (shown in FIG. 3) via the I/O port 33. Microprocessor 41 can also receive inputs from the keypad 25. Microprocessor 41 may be any suitable microprocessor, microcontroller, data processor or the like.

Any of the information provided to terminal 20 may be communicated to a computer or database, which may be remotely located. For example, microprocessor 41 can supply input information to the radio frequency (RF) transceiver 42 for transmission via an antenna 43. The path of RF transmission can be by conventional antenna-to-antenna RF transmission, a microwave link, a satellite link, or the like. Terminal 20 can receive information from a remotely located computer or database via RF transmission in the reverse direction, such as from antenna 43 to RF transceiver 42 to microprocessor 41. Microprocessor 41 can provide some of the received information for display on the display screen 21. The transceiver 43 can operate using one or more modes of communication, individually or simultaneously, including short-range communications (e.g., Bluetooth, WiFi, Zigbee) and long-range communications (e.g., LTE, WiMAX, GSM, CDMA). In one embodiment, the transceiver 43 is a plurality of transceivers that can communicate utilizing different modes of communication.

The microprocessor 41 in terminal 20 preferably has sufficient dedicated memory, either internally at memory 90 or externally, to store various information such as unique account numbers of bankcards and PINs of the employees that frequently use any particular terminal 20 or other information that is desired to be stored locally, such as pending scheduling requests, pending scheduling decisions and/or user profiles. In one embodiment, authentication of employees can be done internally at terminal 20 without having to communicate with a remote computer to access the appropriate account numbers and PINs. In one embodiment, terminal 20 can communicate with a remote computer or database to provide other information associated with a user of the terminal, such as the check-in and checkout times for processing of the payroll.

Terminal 20 can also communicate, separately or in tandem with the RF link, via a modem 45. Modem 45 can have an output terminal or jack 46 to communicate bi-directionally with a remotely located computer or database utilizing one or more of the Public Switched Telephone Network (PSTN), internet, Virtual Private Network (VPN) or the like.

Referring additionally to FIG. 3, there is shown an ATM, payroll and/or work management (APW) system, generally indicated by reference numeral 50. One or more terminals 20 are included in or in communication with the system 50. The terminals 20 can be located at different facilities or at the same facility but at different locations within the facility. Any number of terminals 20 in various configurations can be provided, although three are shown.

One of the terminals 20 is shown with an antenna 43 to transmit radio waves 51 to the antenna 52 of a transceiver 53, which in turn can communicate with a payroll and work management center 55 via one or more lines 54 (and/or wirelessly). While antennas 43 and 52 of terminal 20 and transceiver 53, respectively, are shown as external antennas, it will be appreciated that these antennas 43 and 52 can be internally disposed within the respective terminals. The other terminal 20 can communicate with center 55 via the internet or the PSTN 56. Yet another terminal 20 can communicate with center 55 via a LAN 51 and the internet 56. Thus, the modes and paths of communication between the terminals 20 and the center 55 can vary.

The center 55 can include one or more computers or servers with memory for storing the names of employees, the pay rate for each employee, any deductions from pay for health insurance or the like, the number of the unique bankcard that has been assigned to each employee and/or the PIN associated with each bankcard. The center 55 can include or otherwise store other information, such as scheduling information associated with employees at a location, user profiles associated with employees at a location and so forth. It should be understood that the other information can be stored at the center 55 and/or at other locations, including at each of the terminals 20 or the Human Resources (HR) system 58.

Center 55 can have additional pertinent information concerning one or more of the employees, such as mailing addresses, telephone numbers, communication devices associated with the employees and so forth. In one embodiment, center 55 can obtain information from the employer's HR system 58 via a communication line 59 (and/or wirelessly). The employer's HR system 58 can provide updated employee information to the center 55, such as periodically, as new employees are hired, when the status of an employee changes, and so forth. In one embodiment, dashboard web access 57 can enable real-time monitoring of the status of the system 50, including information on employees that are registered on the system, the number of employees that have checked into work at any particular site, pending scheduling requests for employees, recent scheduling decisions by supervisors, and the like.

In one embodiment, center 55 can also record the time of check-in and the time of checkout for each employee to determine the amount of work time. The pay for each employee can be calculated based upon the recorded work time and the pay rate for each employee. Center 55 can advise the employer of the amount of the payroll. Center 55 can perform an electronic funds transfer (EFT) from employer's bank in the amount of the payroll so that each employee's bank account associated with each bank card 23 will be credited in the net amount of pay for that pay period. The amount of pay can include PTO days that have been cashed, such as through use of the terminal 20. The bank card 23 can be used as a debit card against available funds at point of sale (POS) locations, such as at department stores, grocery stores, gas stations or the like.

One or more communication devices 300 can be in communication with the terminals 20 via the PSTN, internet, LAN and/or wirelessly. The communication devices 300 can be wired devices and/or wireless devices, and can be personal devices or employer-owned devices. The communication devices can also communicate with one or both of the center 55 and the HR system 58. In one embodiment, a presence system 350 can be utilized for generating and maintaining presence information associated with the employees and supervisors, such as through monitoring of communication devices 300 of the employees. For example, the presence system 350 can include one or more presence servers that are aware of various communication devices 300 associated with an employee or supervisor, such as identified by a user profile of the employee or supervisor, and can monitor activity associated with those communication devices, including network authentication, GPS data acquisition, roaming activity and so forth. In one embodiment, polling of the communication devices 300 can be performed to provide more up-to-date presence information for the employee or supervisor, which may or may not include location information for the employee or supervisor. The presence system 350 can be accessed by one or more of the terminals 20, the center 55 and/or the HR system 58 for determining presence of the employee and/or supervisor.

The presence system 350 is depicted in FIG. 3 as being a stand-alone system, which may or may not be operated by a third party, but the exemplary embodiments can include the presence system being integrated with one or more of the terminals 20, the center 55 and/or the HR system 58, including in a distributed or centralized fashion. The exemplary embodiments can also include synchronization techniques with respect to various data that is stored at more than one location. For instance, scheduling information may change based on decisions that are received or otherwise obtained at a terminal 20, and the adjustments to the scheduling information that are being stored at multiple locations, such as at the HR system 58 and the center 55, may be synchronized. User profiles associated with employees and supervisors at a first location may be stored at a terminal 20 at the first location as well as at the HR system 58, and one of the user profiles can be synchronized across the various storage devices upon a change to the user profile (e.g., a user preference not to be contacted on a home telephone number).

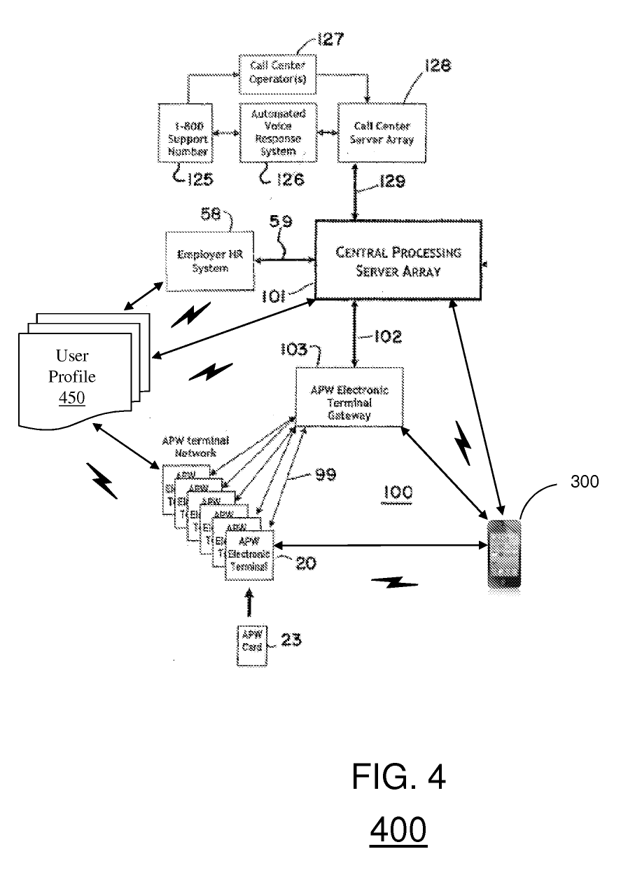

Referring to FIG. 4, a system 400 is shown in which a plurality of terminals 20 communicate via links 99, which may be via a wired connection such as an internet or PSTN link 56 or via a wireless link 51 to an APW electronic terminal gateway 103. Gateway 103 can include modems and transceivers to receive the communications from the terminals 20. Gateway 103 can also include a firewall or other components and/or techniques to protect a central processing server array 101 from unauthorized access. Information to and from the terminals 20 can be communicated between the array 101 and the gateway 103 via lines 102 (or wirelessly). Gateway 103 can be physically located near array 101 or gateway 103 can be located at an employer's site where it communicates with a plurality of terminals 20. The array 101 can represent a portion of, or otherwise operate in, the center 55 of FIG. 3.

User profiles 450 can be stored by one or more of the array 101, the HR system 58 and/or the terminals 20. The user profiles 450 can be stored in a distributed manner, such as being stored locally only at a terminal 20 where the corresponding employees while also being stored at one or both of the array 101 and the HR system 58. In one embodiment, the user profiles are only stored locally at the terminals 20 so that information contained in the user profiles is not being transmitted to and from remote devices. The user profiles 450 can include various information, such as identification information for the user, information descriptive of communication device(s) 300 associated with the user (e.g., device ID information, formatting capability), preferences of the user, skill sets of the user, work efficiency information associated with the user, and so forth. For example, the user profile 450 can include user preferences for contacting the user via one or more of the communication devices 300, such as times to contact the user via a first communication device and times to contact the user via a second communication device. Skill sets of the user, such as provided by the HR system 58 and/or a supervisor of the user, can be included in the user profile to describe capabilities of the user with respect to performing various tasks at work. This information can be utilized as part of the analysis of scheduling information to provide scheduling options for selection by the user and/or for assisting a supervisor in making a scheduling determination. The user profiles can be linked or otherwise associated with other user profiles for individuals that work with a select user, including supervisors of the user, co-workers of the users, and subordinates of the user. By linking or otherwise associating user profiles, the analysis of scheduling information can be facilitated by making information associated with related workers more readily available, such as to determine whether a requested PTO day will impact a department's ability to achieve a work goal based on efficiencies or skill sets of the relevant and available workers.

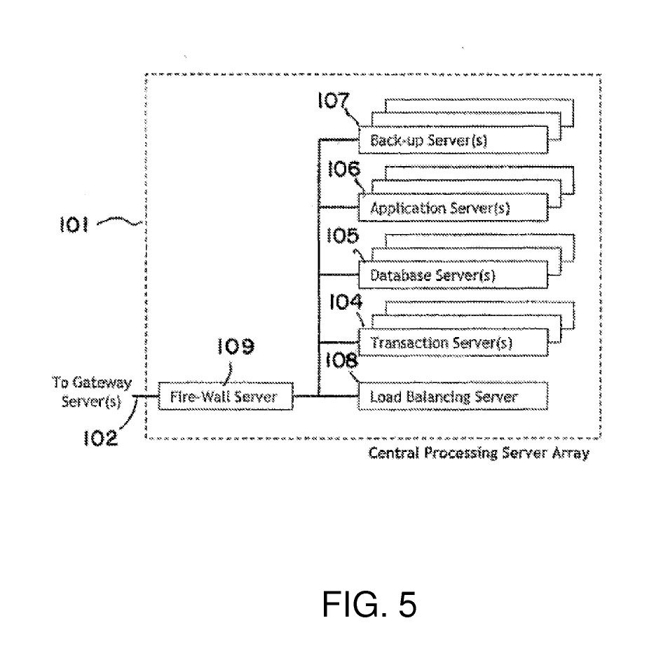

Central processing server array 101 is shown in greater detail in FIG. 5. Array 101 can include a plurality of servers, such as a plurality of transaction servers 104, a plurality of database servers 105, a plurality of application servers 106, a plurality of back-up servers 107 and/or a firewall server 109. The server array 101 can be implemented in a variety of other ways, such as with an Intel™-based computer, a Unix™-based computer, a mainframe computer or the like. Array 101 can operate in as a special purpose computer to receive, send, process and store information.

A plurality of server arrays 101 can be distributed in selected locations in a nationwide system. The terminals 20 can then generally communicate with the nearest server. Back-up servers can also be provided to prevent the loss of stored information and to provide continued processing services in case any one server array becomes non-functional. The system 400 can also include a call center including a toll-free support number 125, an automated voice response (AVR) system, one or more call center operators and/or a call center server array 128. Thus, an employee having difficulty with any terminal 20 may call the toll-free number for help with a scheduling request, a transaction, system status, payroll or balance inquiries or the like. Call center operators 127 may have a personal computer to access the central processing server arrays 101 via the call center server array 128 to obtain information about the inquiring employee's account by first logging into central processing server array 101. When using the AVR system 126 from a remote telephone, the inquiring employee can use the matrix of keys on the telephone to access the desired information by following the commands issued by the voice response system. The employee can log onto array 101 by entering the bank account number on the bank card 23 and then entering the associated PIN or by use of the fingerprint reader 30 or other authentication technique (such as voice or facial recognition), or a combination of these processes depending upon the desires of the employer.

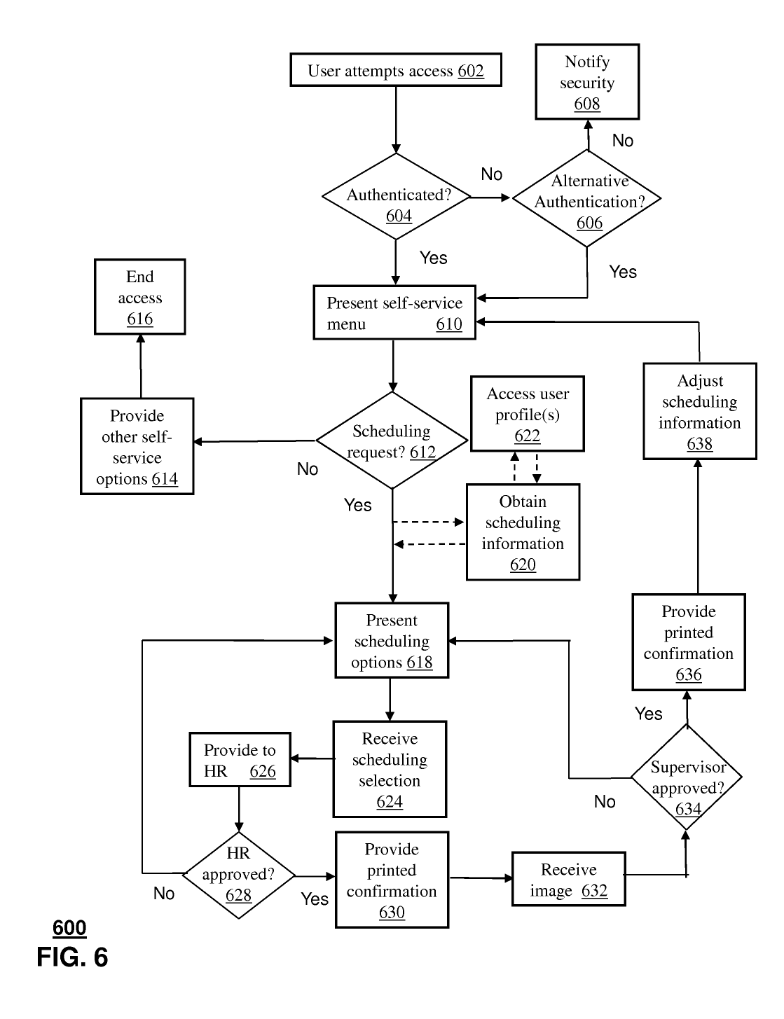

FIG. 6 depicts an illustrative method 600 that operates in portions of the devices and systems of one or more of FIGS. 1-5. Method 600 can begin at 602 with a user attempting to access terminal 20. Access authentication can be performed by the terminal 20 on the user, such as biometric authentication, using one or more of fingerprint reading, voice recognition and facial recognition. In one embodiment, the terminal 20 can utilize fingerprint reader 130 to authenticate the user. The authentication can be based on locally stored data, such as fingerprint identification information stored in the memory of the terminal 20, such as in a user profile. The exemplary embodiments also contemplate the authentication process retrieving data from a remote source, such as the center 55 or the HR system 58.

If at 604 the terminal 20 is unable to authenticate the user then at 606 the terminal 20 can attempt an alternative authentication. For instance, after attempting a fingerprint reading authentication which is unsuccessful, the terminal 20 can capture one or more images of the user utilizing the imaging device 80. In one embodiment, authentication can be performed via facial recognition analysis performed on the captured image(s) by the terminal 20. In another embodiment, the captured image(s) can be transmitted to a remote recipient for authentication, such as to the HR system 58 for identification of the employer. The identification can be based on a recognition analysis performed by a remote server at the HR system 58 and/or can be based on a review by HR personnel comparing the captured image(s) with image(s) of the user stored or otherwise accessible to the HR personnel. In another embodiment, the captured images can be part of a video conference that is provided between the terminal 20 and a video conferencing device at the HR system 20 (or another remote authentication location) where the user's identity can be authenticated during the video conference by personnel participating in the video conference. Other authentication techniques are also contemplated, including use of the bank card 23 in conjunction with the primary and/or secondary authentication techniques.

If after attempting the first and second authentication techniques the user is still not identified then a security message or notice can be issued at 608. For example, security personnel located at the facility where the terminal 20 is located can be provided with an alert message. In one embodiment, where the authentication attempt utilizes a bank card 23 associated with a legitimate user but the authentication attempt(s) fail then one or more communication devices 300 of the legitimate user can be provided with the alert message. It should be understood that while the exemplary embodiment illustrates use of a primary and second authentication process, terminal 20 can utilize any number of authentication processes before terminating the access attempts and/or notifying security, including a single failed authentication attempt based on only one authentication process. In another embodiment, the secondary authentication process can be based on captured audio signals of the user, including based on voice recognition and/or a voice conference with remote personnel. For instance, the display 21 can provide a prompt requesting the user to speak a particular sentence into the audio interface 85 or the terminal 20 can initiate a voice conference between the user and personnel at a remote authentication site. The voice recognition process can be performed locally by the terminal 20, such as based on locally stored voice identification data in a user profile or can be performed remotely, including automatically via voice recognition or via the voice conference.

If the user is authenticated then at 610 a self-service menu can be presented by the terminal 20, such as at the display 21. It should be understood that the presentation of the self-service menu can include graphical and/or audible options (e.g., emitted through audio interface 85). In one embodiment, the presentation of the menu can be based on user preferences, such as identified in the user profile 450. For instance, a user may desire to hear the menu and selectable options rather than read them on the display 21 which can result in the terminal 20 presenting the options via the audio interface 85. The self-service menu can include selectable options for performing a number of tasks, including scheduling requests, retrieving a current schedule including PTO days, cancelling a previously requested PTO day, rolling over or cashing in an unused PTO day, payroll tasks, supply ordering, checking-in or checking-out, updating user profiles, seeking HR information and so forth.

At 612, if the user makes a selection of an option which is not a scheduling request then method 600 can proceed to 614 to provide other self-service options as described above. Once the user is done with utilizing the terminal 20, then access can be terminated at 616. If on the other hand, the user selects an option for making a scheduling request at 612 then at 618 the terminal 20 can present scheduling options to the user. The scheduling options can be presented graphically via the display 21 and/or audibly via the audio interface 85.

In one embodiment, scheduling information can be obtained at 620 to facilitate an analysis and generation of the available scheduling options. The analysis of available scheduling options can be performed by the terminal 20 and/or performed by a remote source, such as the center 55 and/or the HR system 58. The scheduling information can be obtained locally (e.g., from the terminal 20 or from a local memory at the facility such as from another terminal at the same facility or a server of the facility) and/or remotely (e.g., from one or both of the center 55 and/or the HR system 58). The scheduling information can include various information, such as employment schedule data for other users (e.g. co-workers, subordinates or supervisors of the user) that are associated with the user, a work load associated with the user, a work load associated with one or more of the other users, a work efficiency associated with the user, a work efficiency associated with one or more of the other users, a skill set associated with the user and/or a skill set associated with one or more of the other users. In one embodiment at 622, all or a portion of the scheduling information can be retrieved from user profiles associated with the user and/or the other users.

The scheduling options can be presented using various techniques, such as showing calendars with various scheduling scenarios. The scheduling scenarios can be determined by the terminal 20 and/or remotely, including by remote devices at the center 55 and/or the HR system 58, based on the scheduling information. One of the scenarios can be the scheduling or PTO days that are inputted by the user via a user interface of the terminal 20 (e.g., the keypad 20, a touch-sensitive display 21 and/or the audio interface 85). Other scenario can be alternative schedules generated based on the scheduling information, such as to avoid conflicting with PTO days of the other users, to avoid being understaffed based on a particular expected workload for a particular time period, to avoid not having the necessary skilled employees available at a particular time period, and so forth. The scheduling options can be in calendar form where each is graphically distinctive to facilitate understanding of the options.

At 624, the terminal 20 can receive from the user via a user interface of the terminal, a scheduling selection from among the presented options. The scheduling selection can be transmitted or otherwise provided to the HR system 58 for HR review and approval at 626. The HR review can be based on a number of factors, including employer policy, available PTO days, minimum amount of notice for scheduling change, and so forth. The HR review can be an automated process, such as performed by an HR server according to policy and rules that are stored in the HR server for analyzing electronic scheduling selections received from a terminal 20. The HR review can also be based on a review by HR personnel.

At 628 if HR approval is denied then method 600 can return to step 618 to present other scheduling options. The alternative scheduling options can be the same alternative options previously presented and/or can include new alternative options, such as generated based on information provided with the HR denial. For instance, the HR denial can include information describing a new employer policy that does not allow PTO days to be taken during a certain time period, such as during a heavy workload week of the year. This may be a new policy that has not been updated into the scheduling information and thus the original scheduling options may have been generated without the benefit of this criteria. The new alternative scheduling options can be generated based additionally on this new employer policy. The original scheduling information and the HR information (e.g., a reason for denial), if any, provided with the HR denial can be in a format that can be consumed by the terminal 20 or another device that is generating the scheduling options so that the scheduling options can, in one embodiment, be generated without user intervention. However, one or more of the exemplary embodiments also contemplate scheduling options being generated with the assistance of scheduling personnel.

If on the other hand, HR approval is provided at 628 then the terminal 20 can provide a printed confirmation at 630. The printed confirmation of HR approval for the scheduling selection can then be utilized by the user to obtain approval from his or her supervisor. For instance, the user can take the printed confirmation to the supervisor that is available on the floor of the facility and have the supervisor sign or otherwise place an indicia of approval (or denial) on the printed confirmation. In one embodiment, the printed confirmation can include information related to the scheduling selection, such as the schedule of the user's co-workers and subordinates for the relevant time period (e.g., for the PTO day that is being requested), the workload expected for that day, the skill sets of the available workers and so forth. In one embodiment, to facilitate the user tracking the supervisor down for the approval, a message can be sent from the terminal 20 to the communication device 300 of the supervisor, such as a Short Messaging Service (SMS) notice of the scheduling request. Other forms of notice can also be provided, including email, automated voice message, Multimedia Messaging Service (MMS) and so forth. The presence system 350 and supervisor preferences stored in a user profile associated with the supervisor can be utilized to facilitate providing the message of the pending scheduling selection to the supervisor. Once the user obtains the supervisor indicia on the printed confirmation, the user can at 632 utilize the terminal 20 to capture an image (e.g., via scanning or image capture using the imaging device 80) of the printed confirmation with the supervisor indicia. While the user is seeking the signature of the supervisor, the terminal 20 can temporarily log the user out of the terminal or the user can terminate access to the terminal and then log back in once the supervisor's signature is obtained. In one embodiment, the terminal 20 can save the place in the scheduling process so that upon being re-authenticated as in steps 602-606, the user can resume with the scheduling process without going through steps 610-630.

If at 634 the supervisor's indicia indicates a denial of the scheduling selection then method 600 can return to 618 to provide more of the alternative scheduling options. If on the other hand the supervisor's indicia indicates approval of the scheduling request then at 636 a printed confirmation of the scheduling selection, which includes both the HR approval and recognition of the supervisor's approval, can be provided to the user.

The supervisor's indicia can be analyzed in a number of different ways by different devices and/or personnel (e.g., terminal 20, server or personnel at center 55 and/or server or personnel at HR system 58) to determine if the supervisor has approved the scheduling selection. For instance, image recognition can be applied to a supervisor signature on the printed confirmation to determine if the signature is authentic where supervisors only sign if they are approving. In another embodiment, image recognition can be used to authenticate the supervisor's signature on the printed confirmation and to further recognize information written onto the printed confirmation by the supervisor, such as the word “approved”, the word “denied” and/or an explanation for the denial. In one embodiment, the explanation for the denial can be recognized, translated into text, parsed and then utilized for adjusting the scheduling options, such as where the supervisor notes that a particular day has historically been busy resulting in the scheduling options being adjusted (e.g., by the terminal 20) to remove the busy day as an available PTO day. The parsed information can be provided to the particular device performing the generation of the scheduling options, such as the terminal 20, the center 55 and/or the HR system 58.

At 638, the scheduling information can be adjusted based on the approval of the scheduling selection. In one embodiment, the scheduling information adjustment can be performed in real-time so that another employee who subsequently seeks PTO days or other scheduling requests has the benefit of the most up-to-date scheduling information. In another embodiment, scheduling selections that have been made and approved by HR but have not yet been approved by the supervisor can be utilized for temporary adjustments to the scheduling information. In this way, a supervisor's delay in providing approval will not result in penalizing employees with pending scheduling selections or requests where a later requested scheduling of another employee has overlapping PTO days or is otherwise conflicting. Once the supervisor's approval or denial is obtained, the scheduling information can be permanently adjusted accordingly. Following the adjustment of the scheduling information, method 600 can return to step 610 to provide the user with access to other self-service tasks.

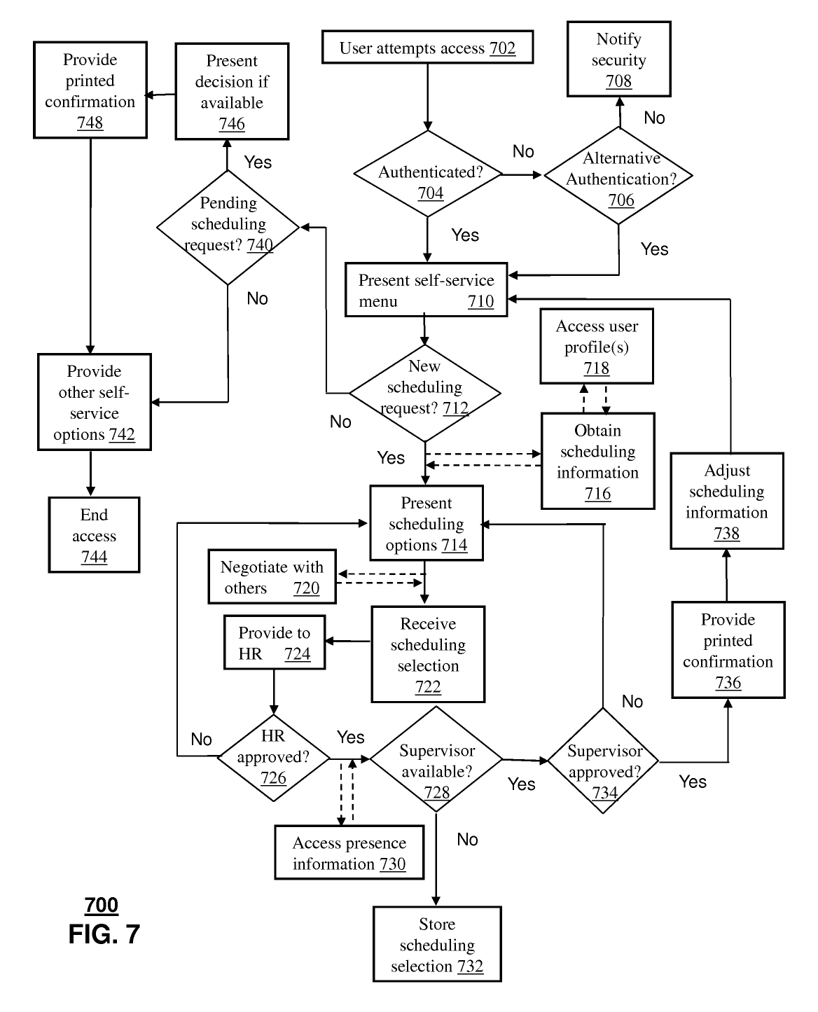

FIG. 7 depicts an illustrative method 700 that operates in portions of the devices and systems of one or more of FIGS. 1-5. Method 700 can be combined with one or more steps described with respect to method 600. Method 700 can begin at 702 when a user attempts to access terminal 20. At 704 and 706, primary and/or alternative authentication processes can be implemented, including fingerprint reading, bank card reading, voice recognition, facial recognition, voice conference with authentication personnel and/or video conference with authentication personnel. The authentication process can vary and can include one or more authentications processes. A security notice can be generated at 708 when there is a failure of the one or more authentication processes.

At 710, a self-service menu can be presented that is graphical, audible or both. The self-service menu can include selectable options for performing a number of tasks, including scheduling requests, retrieving a current schedule including PTO days, cancelling a previously requested PTO day, rolling over or cashing in an unused PTO day, payroll tasks, supply ordering, checking-in or checking-out, updating user profiles, seeking HR information and so forth. In one embodiment, the self-service menu can be presented in an animated fashion, such as utilizing an avatar to present selectable options. The avatar can be generated based on user preferences (e.g., facial features, voice, gender) such as indicated in the user profile or can be a universal avatar provided to all employees.

If at 712, the user selects an option for a new scheduling request then the terminal 20 can present scheduling options at 714. The scheduling options can be presented graphically via the display 21 and/or audibly via the audio interface 85. In one embodiment, scheduling information can be obtained at 716 to facilitate an analysis and generation of the available scheduling options. The analysis of available scheduling options can be performed by the terminal 20 and/or performed by a remote source, such as the center 55 and/or the HR system 58. The scheduling information can be obtained locally (e.g., from the terminal 20 or from a local memory at the facility such as from another terminal at the same facility or a server of the facility) and/or remotely (e.g., from one or both of the center 55 and/or the HR system 58). The scheduling information can include various information, such as employment schedule data for other users (e.g. co-workers, subordinates or supervisors) that are associated with the user, a work load associated with the user, a work load associated with one or more of the other users, a work efficiency associated with the user, a work efficiency associated with one or more of the other users, a skill set associated with the user and/or a skill set associated with one or more of the other users. In one embodiment at 718, all or a portion of the scheduling information can be retrieved from user profiles associated with the user and/or the other users. In one embodiment, access to the scheduling information can be dependent on an employment category of the user. For instance, users in a management position may be able to view scheduling information while subordinates cannot view the scheduling information, but it still can be utilized for generating the scheduling options. In one embodiment, portions of the user profile can be kept confidential from other employees.

The scheduling options can be presented using various techniques, such as showing calendars with various scheduling scenarios. The scheduling scenarios can be determined by the terminal 20 and/or remotely, including by remote devices at the center 55 and/or the HR system 58, based on the scheduling information. One of the scenarios can match up with scheduling or PTO days that are inputted by the user via a user interface of the terminal 20 (e.g., the keypad 20, a touch-sensitive display 21 and/or the audio interface 85). Other scenario can be alternative schedules generated based on the scheduling information, such as to avoid conflicting with PTO days of the other users, to avoid being understaffed based on a particular expected workload for a particular time period, to avoid not having the necessary skilled employees available at a particular time period, and so forth. The scheduling options can be in calendar form where each is graphically distinctive to facilitate understanding of the options.

In one embodiment at 720, the user can engage in negotiation with other users, such as co-workers or subordinates, exchange scheduling adjustments. For example, a user can negotiate with another user to exchange PTO days. The negotiation can be performed in a number of different ways. For example, the terminal 20 can utilize presence information and user preferences to provide messages to the other users for exchanging the PTO days. In another example, a message can be left at the terminal so that the next time the user logs in the message and request for exchanging of the PTO days will be provided to the other users. In one embodiment, the negotiation of the PTO days can be subject to employer policies. For example, the employer may require that when a first user receives a requested exchange of PTO days with a second user then the first user must agree to a future exchange of PTO days upon the second user making such a request. The scheduling information can be adjusted based on the negotiation between users for scheduling.

At 722, the terminal 20 can receive a scheduling selection from among the presented options. The scheduling selection can be transmitted or otherwise provided to the HR system 58 for HR review and approval at 724. The HR review can be based on a number of factors, including employer policy, available PTO days, minimum amount of notice for scheduling change, and so forth. The HR review can be an automated process, such as performed by an HR server according to policy and rules that are stored in the HR server for analyzing electronic scheduling selections received from a terminal 20. The HR review can also be based on a review by HR personnel.

At 726 if HR approval is denied then method 700 can return to step 714 to present other scheduling options, including scheduling options based on any reasoning provided for the HR denial.

If on the other hand HR approval is provided at 726 then the terminal 20 can determine if the supervisor is available for making a scheduling determination at 728. The availability of the supervisor can be based on various information. For example at 730, the terminal 20 can access presence information from the presence system to determine the availability of the supervisor. Supervisor preferences can also be accessed, such as stored in a user profile for the supervisor. In one embodiment, messaging or other notices can be sent to the supervisor via one or more communication devices 300 of the supervisor, such as via SMS, MMS, email, automated voice message and so forth. A time limit for response by the supervisor can be set to determine if the supervisor is deemed to be available. In one embodiment, the terminal 20 or other sensors in the facility can emit a scanning signal (e.g., a short range communication signal such as an infrared signal) as a probe or polling signal to determine the location of the supervisor. For instance, the supervisor may have a communication device 300 that can automatically respond to such a scanning signal to indicate the supervisor's location without the supervisor needing to manually respond to a message.

If the supervisor is deemed to be unavailable at 728 then at 732 the scheduling selection of the user can be stored in the memory of the terminal 20 or elsewhere, including remotely at the center 55 or the HR system 58. In one embodiment, periodic messages or notices can be provided to the supervisor to advise of the stored scheduling selection so that the supervisor can access the terminal 20 for providing approval or otherwise communicate the approval of the scheduling selection. In one embodiment, the supervisor can directly communicate an approval of a scheduling selection to the center 55 and/or the HR system 58, such as where the supervisor later accesses the stored scheduling selection but the user is no longer available to receive the supervisor's approval.

If the supervisor is available then at 734, a determination can be made as to whether the supervisor has approved the scheduling selection. For instance, the message transmitted to the communication device 300 of the supervisor notifying the supervisor of the scheduling selection can have details as to the selection, including all or a portion of the scheduling information so that the supervisor can make an informed decision. In this example, the supervisor can respond to the message with an approval or a denial. Other methods of responding to the scheduling selection are also contemplated, such as the supervisor directly advising the center 55 and/or the HR system 58 of his or her approval or denial, which is sent from an authenticated communication device 300 of the supervisor.

If it is determined at 734 that the supervisor has denied the scheduling selection then method 700 can return to step 714 to present scheduling options. In one embodiment, the denial by the supervisor can include a reason for the denial which can be utilized, such as parsing of a text message or analysis of a supervisor's selection in the message (e.g., the message can include options for the supervisor to select to explain the reason for the denial), for generation of the alternative scheduling options.

If it is determined at 734 that the supervisor has approved the scheduling selection then method 700 can proceed to step 736 and provide a printed confirmation of the scheduling determination of the supervisor along with the previous HR approval of same. At 738, the scheduling information can be adjusted according to the denial or approval of the scheduling selection by the user. Method 700 can then return to 710 and present the self-service menu to the user, which will allow termination of the access to the terminal 20 if the user so desires.

Returning back to step 712, if on the other hand the user has not selected a new scheduling request then at 740 the terminal 20 can determine if the user has any pending scheduling requests. A pending scheduling request is a scheduling request previously made by the user that did not receive a supervisor's determination at the time, such as being stored at 732. If there are no pending scheduling requests then method 700 can proceed to 742 to present other self-service options and at 744 terminate access to the terminal 20 once the user is done with the other self-service options. If on the other hand the user does have one or more pending scheduling requests then at 746 the terminal 20 can present the supervisor's determination where available. For instance, a supervisor may have logged into the terminal 20, may have been provided with the scheduling request and may have made a scheduling decision, which was stored. The supervisor may have also provided the scheduling determination to a different recipient, such as to center 55 and/or HR system 58, which stored the supervisor's determination. Terminal 20 can search for stored supervisor decisions associated with a current user and can provide the current user with the determination, such as via the display 21 and/or the audio interface 85. At 748, a printed confirmation can be provided to the user which indicates the approval by the supervisor as well as the previous approval by HR. Method 700 can then proceed to 742 and 744 for providing other self-service options and terminating access to the terminal 20.

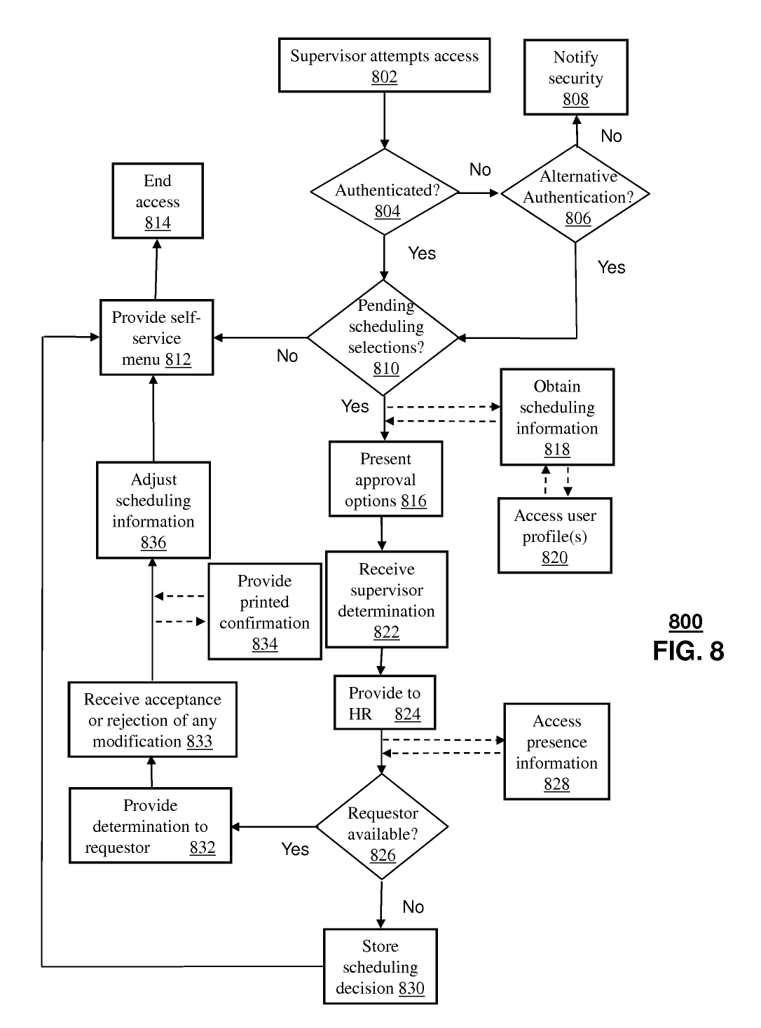

FIG. 8 depicts an illustrative method 800 that operates in portions of the devices and systems of one or more of FIGS. 1-5. Method 800 can be combined with one or more steps described with respect to methods 600 and/or 700. Method 800 can begin at 802 when a supervisor attempts to access terminal 20. At 804 and 806, primary and/or alternative authentication processes can be implemented, including fingerprint reading, bank card reading, voice recognition, facial recognition, voice conference with authentication personnel and/or video conference with authentication personnel. The authentication process can vary and can include one or more authentications processes. A security notice can be generated at 808 when there is a failure of the one or more authentication processes. In one embodiment, the authentication requirements can be heightened due to the access being sought by a supervisor that may, via the terminal 20, have access to more self-service options and access to more critical information associated with the employer.

At 810, a determination can be made as to whether the supervisor has any pending scheduling selections. A pending scheduling selection is a scheduling selection that has been made by an employee and approved by HR, but has not yet been approved by the supervisor. If there are no pending scheduling selections for the supervisor then method 800 can proceed to 812 to present a self-service menu that is graphical, audible or both. The self-service menu can include selectable options for performing a number of tasks, including scheduling requests (for the supervisor), retrieving a current schedule including PTO days, cancelling a previously requested PTO day, rolling over or cashing in an unused PTO day, payroll tasks, supply ordering, checking-in or checking-out, updating user profiles, seeking HR information and so forth. In one embodiment, the self-service menu can be presented in an animated fashion, such as utilizing an avatar to present selectable options. The avatar can be generated based on user preferences such as indicated in the user profile or can be a universal avatar provided to all employees. Once the supervisor has exhausted use of the self-service menu then at 814 access to the terminal 20 can be terminated.

If on the other hand at 810, there are one or more pending scheduling selections to be reviewed by the supervisor then at 816 the terminal 20 can present approval options at 816. The approval options can be presented graphically via the display 21 and/or audibly via the audio interface 85. In one embodiment, scheduling information can be obtained at 818 to facilitate an analysis and generation of the available approval options. The analysis of available approval options can be performed by the terminal 20 and/or performed by a remote source, such as the center 55 and/or the HR system 58. The scheduling information can be obtained locally (e.g., from the terminal 20 or from a local memory at the facility such as from another terminal at the same facility or a server of the facility) and/or remotely (e.g., from one or both of the center 55 and/or the HR system 58). The scheduling information can include various information, such as employment schedule data for other users (e.g. co-workers, subordinates or supervisors) that are associated with the user, a work load associated with the user, a work load associated with one or more of the other users, a work efficiency associated with the user, a work efficiency associated with one or more of the other users, a skill set associated with the user and/or a skill set associated with one or more of the other users. In one embodiment at 820, all or a portion of the scheduling information can be retrieved from user profiles associated with the user and/or the other users.

In one embodiment, the scheduling information viewable by the supervisor can exceed the scheduling information made available to the user requesting the scheduling. For instance, users in a management position may be able to view scheduling information while subordinates cannot view the scheduling information but such information can still be utilized for generating the scheduling options. In one embodiment, the scheduling options that were presented to the user (e.g., in method 700) can be different from the approval options presented to the supervisor. For example, the supervisor may indicate, when presented with the approval options, that a particular day will have a heavy workload. The approval options can then be re-analyzed and alternative approval options can be generated. In one embodiment, the generation of the approval options for the supervisor can be an interactive and/or iterative process where the supervisor provides feedback at various steps of the generation of the approval options, such as placing weight on the need for a certain skill set or giving priority to scheduling requests of one employee over another due to efficiency discrepancies. Thus, in one embodiment, the scheduling options presented to the user requesting the scheduling can be different from the approval options presented to the supervisor even though a portion of the scheduling information used to generate both may be the same.

The approval options can be presented using various techniques, such as showing calendars with various scheduling scenarios, including workload, skill set and/or efficiency statistics associated with each of the potential scenarios. The scheduling scenarios can be determined by the terminal 20 and/or remotely, including by remote devices at the center 55 and/or the HR system 58, based on the scheduling information. One of the scenarios can match up with scheduling or PTO days that are inputted by the user via a user interface of the terminal 20 (e.g., the keypad 20, a touch-sensitive display 21 and/or the audio interface 85). Other scenarios can be alternative schedules generated based on the scheduling information, such as to avoid conflicting with PTO days of the other users, to avoid being understaffed based on a particular expected workload for a particular time period, to avoid not having the necessary skilled employees available at a particular time period, and so forth. The approval options can be in calendar form where each is graphically distinctive to facilitate understanding of the options.

At 822, the terminal 20 can receive a supervisor decision or determination inputted via a user interface by the supervisor, such as from among the presented options. The supervisor determination can be transmitted or otherwise provided to the HR system 58 (including for HR review and approval where needed) at 824.

At 826, the terminal 20 can determine if the requesting employee is available for receiving the determination. The availability of the requesting employee can be based on various information. For example at 828, the terminal 20 can access presence information from the presence system to determine the availability of the employee. Employee preferences can also be accessed, such as stored in a user profile for the requesting employee. In one embodiment, messaging or other notices can be sent to the employee via one or more communication devices 300 of the employee, such as via SMS, MMS, email, automated voice message and so forth. A time limit for response by the employee can be set to determine if the employee is deemed to be available. In one embodiment, the terminal 20 or other sensors in the facility can emit a scanning signal (e.g., a short range communication signal such as an infrared signal) as a probe or polling signal to determine the location of the employee.

If the employee is deemed to be unavailable at 826 then at 830 the supervisor determination can be stored in the memory of the terminal 20 or elsewhere, including remotely at the center 55 or the HR system 58. In one embodiment, periodic messages or notices can be provided to the employee to advise of the stored supervisor determination.

If the requesting employee is available then at 832 the supervisor determination can be provided to the requesting employee. For instance, the message can be transmitted to the communication device 300 of the employee notifying the employee of the supervisor determination. In one embodiment at 833, where the supervisor determination deviates from the scheduling selection of the employee, details as to the deviation can be provided in the message. In this example, the employee can respond to the message with an acceptance of the modification or a rejection of the modification.

In one embodiment, the rejection by the employee of the modification can include a reason for the rejection which can be utilized, such as parsing of a text message or analysis of an employee's selection in the message (e.g., the message can include options for the employee to select to explain the reason for the rejection of the modification), for generation of alternative approval options to be reviewed by the supervisor.

At 834, a printed confirmation can be provided of the supervisor determination and/or the employee's acceptance or rejection of any modification. At 836, the scheduling information can be adjusted according to the supervisor determination. Method 800 can then return to 812 and present the self-service menu to the supervisor, which will allow termination of the access to the terminal 20 if the supervisor so desires at 814.

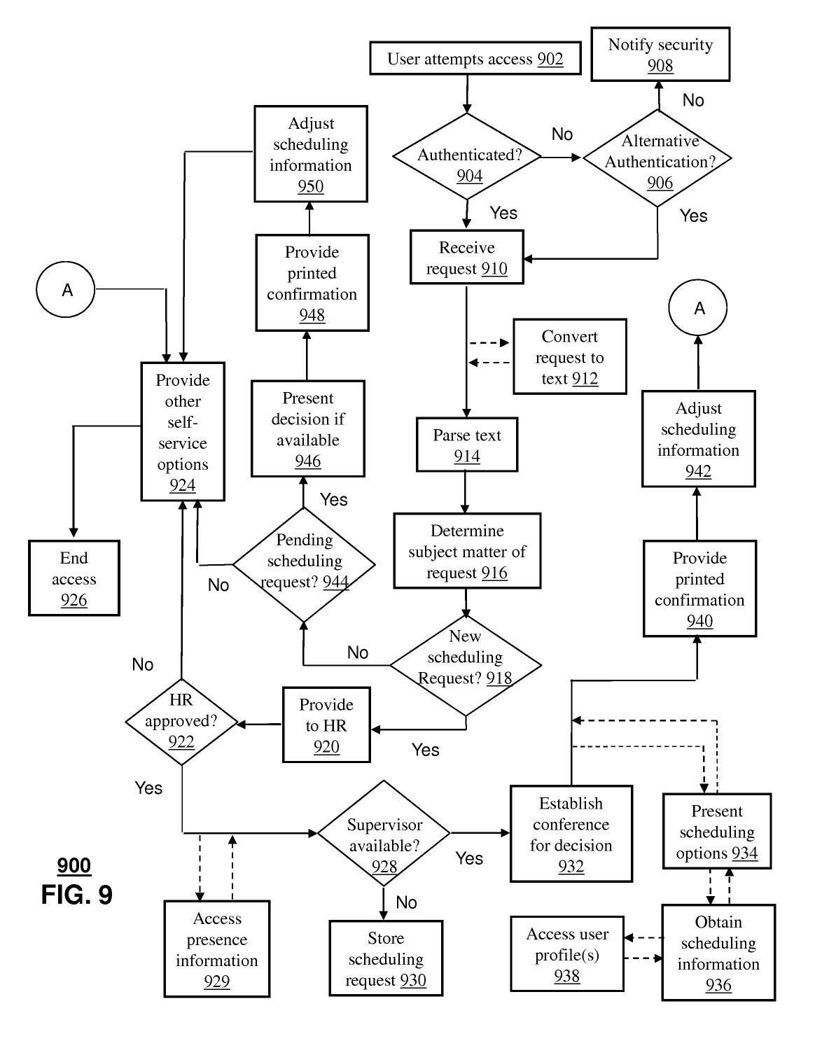

FIG. 9 depicts an illustrative method 900 that operates in portions of the devices and systems of one or more of FIGS. 1-5. Method 900 can be combined with one or more steps described with respect to methods 600, 700 and/or 800. Method 900 can begin at 902 when a user (e.g., an employee desiring to obtain an adjustment to their schedule such as obtaining a PTO day) attempts to access terminal 20. At 904 and 906, primary and/or alternative authentication processes can be implemented, including fingerprint reading, bank card reading, voice recognition, facial recognition, voice conference with authentication personnel and/or video conference with authentication personnel. The authentication process can vary and can include a single authentication process or multiple authentications processes as illustrated. A security notice can be generated at 908 when there is a failure of the one or more authentication processes. In one embodiment, the authentication process can be designated by the user based on a user preference, such as identified in a user profile for the user. For instance, the user can swipe or otherwise provide the user's card 23 as an initial identification of the user and then terminal 20 can seek authentication of the user via an authentication process identified in a user profile associated with the user that is stored in a memory accessible by the user, such as memory 90 and/or a remote memory (e.g., stored at center 55 and/or HR system 58). The user may have a preference as to the authentication process for a number of reasons, such as a history of difficulty in authenticating the user's fingerprints or difficulty in recognizing the user's voice. In one embodiment, the authentication process can be determined for each user based on a history of authentication difficulties. For example, the terminal 20, center 55 and/or HR system 58 can monitor past authentications of the user and determine if one process is more efficient than another, such as based on a number of authentication failures associated with a particular process.

At 910, the terminal 20 can receive a user input via a user interface of the terminal such as the keypad 25 or the audio interface 85. In one embodiment, the user input can be in response to presentation of a self-service menu. For example, the menu can be presented with selectable options, including an option for “requests” or an option for “other.” Where the request is received as a voice input, it can be converted to text using voice recognition at 912. The conversion to text can be performed locally by the terminal 20 and/or remotely, such as by the center 55 and/or the HR system 58. At 914, the text (e.g., converted from voice input or entered by the user via the keypad 25) can be parsed. The parsing of the text can be performed locally by the terminal 20 and/or remotely, such as by the center 55 and/or the HR system 58. At 916, the parsed text can be analyzed to determine a subject matter or meaning for the request. The analysis of the parsed text can be performed locally by the terminal 20 and/or remotely, such as by the center 55 and/or the HR system 58. The analysis can utilize various components and techniques, including accessing various libraries, natural language engines and so forth.

If the request is a new scheduling request at 918 then method 900 can proceed to 920 to transmit or otherwise provided the request (e.g., in its parsed and analyzed form) to the HR system 58 for HR review and approval at 920. The HR review can be based on a number of factors, including employer policy, available PTO days, minimum amount of notice for scheduling change, and so forth. The HR review can be an automated process, such as performed by an HR server according to policy and rules that are stored in the HR server for analyzing electronic scheduling selections received from a terminal 20. The HR review can also be based on a review by HR personnel.

At 922 if HR approval is denied then method 700 can proceed to step 924 to present self-service options, which can include scheduling options based on any reasoning provided for the HR denial. The self-service menu of options can include selectable options for performing a number of tasks, including scheduling requests, retrieving a current schedule including PTO days, cancelling a previously requested PTO day, rolling over or cashing in an unused PTO day, payroll tasks, supply ordering, checking-in or checking-out, updating user profiles, seeking HR information and so forth. In one embodiment, the self-service menu can be presented in an animated fashion, such as utilizing an avatar to present selectable options. The avatar can be generated based on user preferences such as indicated in the user profile or can be a universal avatar provided to all employees. Once the user has exhausted use of the self-service menu then at 926 access to the terminal 20 can be terminated.

If on the other hand HR approval is provided at 922 then the terminal 20 can determine if the supervisor is available for making a scheduling determination at 928. The availability of the supervisor can be based on various information. For example at 929, the terminal 20 can access presence information from the presence system to determine the availability of the supervisor. Supervisor preferences can also be accessed, such as stored in a user profile for the supervisor. In one embodiment, messaging or other notices can be sent to the supervisor via one or more communication devices 300 of the supervisor, such as via SMS, MMS, email, automated voice message and so forth. A time limit for response by the supervisor can be set to determine if the supervisor is deemed to be available. In one embodiment, the terminal 20 or other sensors in the facility can emit a scanning signal (e.g., a short range communication signal such as an infrared signal) as a probe or polling signal to determine the location of the supervisor. For instance, the supervisor may have a communication device 300 that can automatically respond to such a scanning signal to indicate the supervisor's location without the supervisor needing to manually respond to a message.

If the supervisor is deemed to be unavailable at 928 then at 930 the parsed and analyzed scheduling request of the user can be stored in the memory of the terminal 20 or elsewhere, including remotely at the center 55 or the HR system 58. In one embodiment, periodic messages or notices can be provided to the supervisor to advise of the stored request so that the supervisor can access the terminal 20 for providing approval or otherwise communicate the approval of the scheduling selection. In one embodiment, the supervisor can directly communicate an approval of a scheduling request to the center 55 and/or the HR system 58, such as where the supervisor later accesses the stored request but the user is no longer available to receive the supervisor's approval.

If on the other hand the supervisor is determined to be available at 928 then at 932 a conference can be initiated between the user and the supervisor. The conference can be a voice conference or a video conference. The conference can utilize the terminal 20 as the end user device for the user and can use communication device 300 or another terminal 20 accessible by the supervisor as the end user device for the supervisor. In one embodiment, the supervisor can be presented (e.g., graphically at the supervisor's end user device) with the parsed request so that the supervisor can reference the request during the conference.

In one embodiment at 934, scheduling options can be presented during the conference. The scheduling options can be presented graphically and/or audibly. The scheduling options can be presented to one or both of the user and the supervisor. In one embodiment, the scheduling options presented to the user can be different, in whole or in part, from the scheduling options presented to the supervisor. For instance, the user can see limited scheduling options based on their original request (e.g., only the PTO days that the user requested). In this example, the supervisor can see all of the alternative PTO days that are generated based on the scheduling information.

In one embodiment, scheduling information can be obtained at 936 to facilitate an analysis and generation of the available scheduling options. The analysis of available scheduling options can be performed by the terminal 20 and/or performed by a remote source, such as the center 55 and/or the HR system 58. The scheduling information can be obtained locally (e.g., from the terminal 20 or from a local memory at the facility such as from another terminal at the same facility or a server of the facility) and/or remotely (e.g., from one or both of the center 55 and/or the HR system 58). The scheduling information can include various information, such as employment schedule data for other users (e.g. co-workers, subordinates or supervisors) that are associated with the user, a work load associated with the user, a work load associated with one or more of the other users, a work efficiency associated with the user, a work efficiency associated with one or more of the other users, a skill set associated with the user and/or a skill set associated with one or more of the other users. In one embodiment at 938, all or a portion of the scheduling information can be retrieved from user profiles associated with the user and/or the other users. In one embodiment, access to the scheduling information can be dependent on the viewer. For instance, the supervisor may be able to view scheduling information while the requesting user cannot view the scheduling information.

The scheduling options can be presented using various techniques, such as showing calendars with various scheduling scenarios. The scheduling scenarios can be determined by the terminal 20 and/or remotely, including by remote devices at the center 55 and/or the HR system 58, based on the scheduling information. One of the scenarios can match up with scheduling or PTO days that are inputted by the user via a user interface of the terminal 20 (e.g., the keypad 20, a touch-sensitive display 21 and/or the audio interface 85). Other scenarios can be alternative schedules generated based on the scheduling information, such as to avoid conflicting with PTO days of the other users, to avoid being understaffed based on a particular expected workload for a particular time period, to avoid not having the necessary skilled employees available at a particular time period, and so forth. The scheduling options can be in calendar form where each is graphically distinctive to facilitate understanding of the options.

In one embodiment, the conference can initiate or attempt communication with other employees to engage in a discussion or negotiation with the other employees, such as co-workers or subordinates of the user, to exchange scheduling adjustments.

If a decision is reached during the conference, then a printed confirmation of the scheduling determination of the supervisor along with the previous HR approval can be provided by the terminal 20 at 940. In one embodiment, the supervisor can advise the terminal 20, the center 55, and/or the HR system 58 as to the scheduling determination being reached, such as providing a message (e.g., a selectable option or a parsed input of the supervisor) advising same. At 942, the scheduling information can be adjusted according to the scheduling information. Method 900 can then proceed to 924 and present the self-service menu to the user, which will allow termination of the access to the terminal 20 at 926 if the user so desires.

Returning back to 918, if the request is not associated with a new scheduling request then at 944 a determination can be made as to whether the request is associated with a pending scheduling request or whether the user has any pending scheduling requests. A pending scheduling request is a scheduling request that has previously been made by the user but has not been resolved (e.g., the supervisor was unavailable or the conference between the user and supervisor did not result in a scheduling determination). If there are no pending scheduling requests for the user then method 900 can proceed to 924 to present a self-service menu that is graphical, audible or both.

If on the other hand at 944, there are one or more pending scheduling requests then at 946 the terminal 20 can present a supervisor determination if it is available. At 948, a printed confirmation can be provided of the supervisor determination and the HR approval associated with the pending scheduling request. At 950, the scheduling information can be adjusted according to the supervisor determination. Method 900 can then return to 924 and present the self-service menu to the user, which will allow termination of the access to the terminal 20 if the user so desires at 926.

Upon reviewing the aforementioned embodiments, it would be evident to an artisan with ordinary skill in the art that said embodiments can be modified, reduced, or enhanced without departing from the scope and spirit of the claims described below. For example, one or more of the exemplary embodiments can enable a scheduling request to be recorded (e.g., voice and/or video) and stored by the electronic terminal 20 so that the HR system 58 and/or the supervisor can access the request at a subsequent time for making a decision. In this example, the terminal 20 can be utilized as a depository for requests and approvals, where employees, supervisors and/or HR personnel may not be immediately available. In one embodiment, the scheduling requests and approvals can be monitored for generating or otherwise adjusting employer policies. For instance, monitoring of requests and approvals can indicate that requests are being made too close to the desired PTO day or that approvals are taking too long to be provided by the supervisors. Employer policies can then be set with time limits for providing the requests or decisions.

In another embodiment, user preferences can be accessed (e.g., in a user profile) which indicate that notices of scheduling requests or determinations are to go directly to a voice mail of the associated communication device of the employee or supervisor.

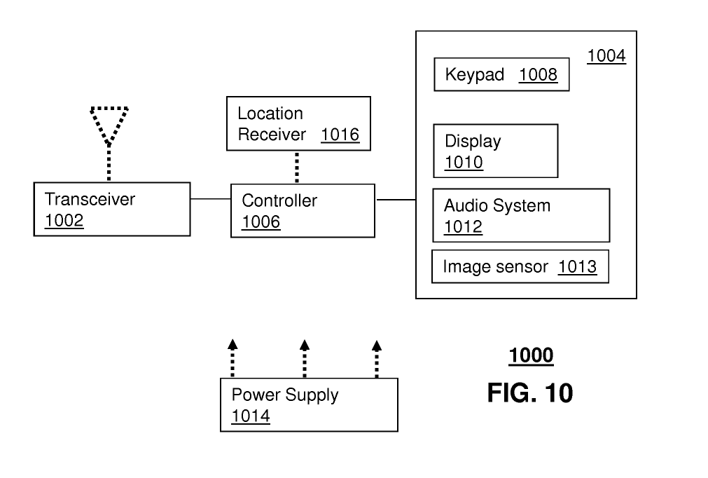

FIG. 10 depicts an exemplary embodiment of a communication device 1000. Communication device 1000 can serve in whole or in part as an illustrative embodiment of user endpoint devices, such as the communication devices 300 of the user, the co-workers, the subordinates, the supervisors and/or other entities, such as depicted in FIGS. 3-4 and/or as utilized in the methods of FIGS. 6-9. The communication device 1000 can function as a caller and/or callee's end user device (e.g., for a video or telephone conference that includes a schedule requesting user and a supervisor) that can participate in a voice call, video call and/or messaging session regardless the compatibility of the devices and/or the compatibility of the networks in which the devices are operating. The communication device 1000 can comprise a wireline and/or wireless transceiver 1002 (herein transceiver 1002), a user interface (UI) 1004, a power supply 1014, a location receiver 1016, and a controller 1006 for managing operations thereof. The transceiver 1002 can support short-range or long-range wireless access technologies such as Bluetooth, WiFi, Digital Enhanced Cordless Telecommunications (DECT), and/or other cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation cellular wireless communication technologies as they arise. The transceiver 1002 can also be adapted to support circuit-switched wireline access technologies (such as PSTN), packet-switched wireline access technologies (such as various forms of IEEE 802.11 networking technologies, TCP/IP, VoIP, etc.), and combinations thereof.

The UI 1004 can include a depressible or touch-sensitive keypad 1008 with a navigation mechanism such as a roller ball, a thumbwheel, a joystick, a mouse, or a navigation disk for manipulating operations of the communication device 1000. The keypad 1008 can be an integral part of a housing assembly of the communication device 1000 or an independent device operably coupled thereto by a tethered wireline interface (such as a USB cable) or a wireless interface supporting for example Bluetooth. The keypad 1008 can represent a numeric dialing keypad commonly used by phones, and/or a Qwerty keypad with alphanumeric keys used by smart phones. The UI 1004 can further include a display 1010 such as monochrome or color LCD (Liquid Crystal Display), OLED (Organic Light Emitting Diode) or other suitable display technology for conveying images to an end user of the communication device 1000. In an embodiment where the display 1010 is touch-sensitive, a portion or all of the keypad 1008 can be presented by way of the display 1010 with navigation features.

The UI 1004 can also include an audio system 1012 that utilizes common audio technology for conveying low volume audio (such as audio heard only in the proximity of a human ear) and high volume audio (such as speakerphone for hands free operation). The audio system 1012 can further include a microphone for receiving audible signals of an end user. The audio system 1012 can also be used for voice recognition applications. The UI 1004 can further include an image sensor 1013 such as a charged coupled device (CCD) camera for capturing still or moving images.

The power supply 1014 can utilize common power management technologies such as replaceable and rechargeable batteries, supply regulation technologies, and charging system technologies for supplying energy to the components of the communication device 1000 to facilitate long-range or short-range portable applications. The location receiver 1016 can utilize common location technology such as a global positioning system (GPS) receiver capable of assisted GPS for identifying a location of the communication device 1000 based on signals generated by a constellation of GPS satellites, thereby facilitating common location services such as navigation. Location data from location receiver 1016 can be provided to presence system 350 and/or electronic terminal 20 to facilitate communication between the user of the terminal and another entity such as a supervisor or a user who has requested a scheduling decision from the supervisor. The location data can be utilized in a number of different ways, including initiating a conference to obtain a scheduling decision or determining an availability of an entity, such as a supervisor, a user who has requested a scheduling decision from the supervisor or other employees participating in a scheduling negotiation with the user requesting the scheduling decision.

The communication device 1000 can use the transceiver 1002 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 1006 can utilize computing technologies such as a microprocessor, a digital signal processor (DSP), and/or a video processor with associated storage memory such a Flash, ROM, RAM, SRAM, DRAM or other storage technologies.

The communication device 1000 can be adapted to perform the functions of one or more of the communication or user end point devices of FIGS. 3-4 and FIGS. 6-9. It will be appreciated that the communication device 1000 can also represent other common devices that can operate in one or more of the communication systems of FIGS. 3-4 and the methods of FIGS. 6-9.

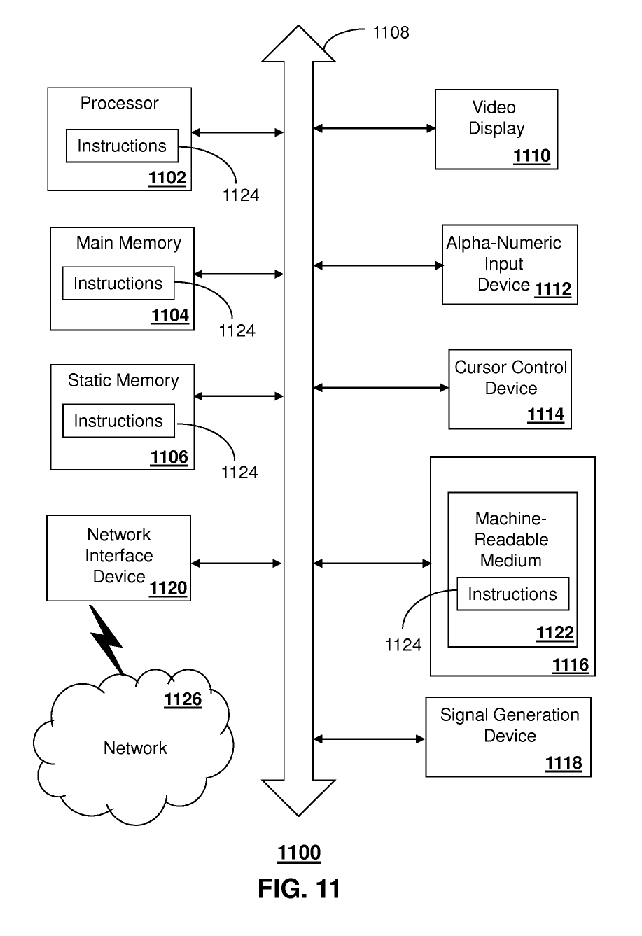

FIG. 11 depicts an exemplary diagrammatic representation of a machine in the form of a computer system 1100 within which (e.g., stored on a non-transitory storage medium) a set of instructions, when executed, may cause the machine to perform any one or more (or portions thereof) of the methods discussed above. One or more instances of the machine can operate, for example, as the electronic terminal 20, the payroll and work management center 55, the HR system 58, the central processing server array 101 and/or the presence system 350. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. It should be understood that the exemplary embodiments include one or more functions of an individual device being distributed among a plurality of devices.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 1100 may include a processor 1102 (e.g., a central processing unit (CPU), a graphics processing unit (GPU, or both), a main memory 1104 and a static memory 1106, which communicate with each other via a bus 1108. The computer system 1100 may further include a video display unit 1110 (e.g., a liquid crystal display (LCD), a flat panel, or a solid state display. The computer system 1100 may include an input device 1112 (e.g., a keyboard), a cursor control device 1114 (e.g., a mouse), a disk drive unit 1116, a signal generation device 1118 (e.g., a speaker or remote control) and a network interface device 1120.

The disk drive unit 1116 may include a tangible computer-readable storage medium 1122 on which is stored one or more sets of instructions (e.g., software 1124) embodying any one or more of the methods or functions described herein, including those methods illustrated above. The instructions 1124 may also reside, completely or at least partially, within the main memory 1104, the static memory 1106, and/or within the processor 1102 during execution thereof by the computer system 1100. The main memory 1104 and the processor 1102 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 1122 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., LTE, WiMAX, GSM, CDMA) are contemplated for use by computer system 1100.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. One or more of the method steps described herein can be removed, performed in another sequence, and/or performed individually or simultaneously. Other method steps can also be added to the techniques described herein. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus, comprising:
a memory;
a user interface;
a display device; and
a controller circuit coupled to the memory, the user interface and the display device, wherein the controller circuit is programmed to:
present a self-service graphical user interface (GUI) on the display device;
receive a GUI selection from the self-service GUI that is inputted via the user interface;
obtain scheduling options responsive to the GUI selection being a request for scheduling for a user, wherein the scheduling options are determined based on scheduling information, and wherein the scheduling information comprises employment schedule data for other users that are associated with the user;
present the scheduling options on the display device;
receive a scheduling selection from among the scheduling options that is inputted by the user via the user interface;
provide the scheduling selection to a remote server for evaluation;
receive a human resources approval associated with the scheduling selection from the remote server; and
provide a printed confirmation of the human resources approval.

2. The apparatus of claim 1, wherein the controller circuit is programmed to:
capture an image of the printed confirmation having an indicia from a supervisor, wherein the indicia represents a scheduling determination by the supervisor; and
provide a determination message to the remote server responsive to capturing the image.

3. The apparatus of claim 1, wherein the controller circuit is programmed to:
receive one or more requested paid time off days that are inputted by the user via the user interface, wherein the scheduling options presented on the display device are determined based in part on the one or more requested paid time off days, and wherein the scheduling options comprise one or more alternative paid time off days that are different from the one or more requested paid time off days.

4. The apparatus of claim 1, wherein the scheduling information further comprises at least one of a work load associated with the user, a work load associated with one or more of the other users, a work efficiency associated with the user, a work efficiency associated with one or more of the other users, a skill set associated with the user or a skill set associated with one or more of the other users.

5. The apparatus of claim 1, wherein the controller circuit is programmed to:
provide the scheduling selection to the supervisor for a scheduling determination.

6. The apparatus of claim 1, wherein the controller circuit is programmed to:
determine an availability of a supervisor associated with the user responsive to receiving the human resources approval;
store the scheduling selection in the memory when the supervisor is determined to be unavailable; and
provide the scheduling selection to the supervisor for a scheduling determination when the supervisor is determined to be available.

7. The apparatus of claim 6, wherein the controller circuit is programmed to:
monitor for access of the apparatus by the supervisor, wherein the supervisor is determined to be available based on the monitored access; and
provide the scheduling selection on the display device for the scheduling determination by the supervisor responsive to the supervisor accessing the apparatus.

8. The apparatus of claim 6, wherein the controller circuit is programmed to:
provide the scheduling selection to the supervisor for the scheduling determination via a video conference utilizing at least the user interface and the display device when the supervisor is determined to be available.

9. The apparatus of claim 6, wherein the controller circuit is programmed to:
provide a printed confirmation of at least one of the scheduling selection, the human resources approval or the scheduling determination.

10. The apparatus of claim 6, wherein the controller circuit is programmed to generate adjustment signals for adjusting the scheduling information based on the scheduling selection prior to the scheduling determination being rendered.

11. The apparatus of claim 6, wherein the controller circuit is programmed to:
terminate access to the apparatus for the user;
receive the scheduling determination;
store the scheduling determination in the memory;
monitor for subsequent access of the apparatus by the user; and
provide the scheduling determination on the display device responsive to the user subsequently accessing the apparatus.

12. The apparatus of claim 1, wherein the controller circuit is programmed to:
receive an access request from the user via the user interface;
authenticate the access request using a first mode of authentication;
authenticate the access request using a second mode of authentication responsive to an unsuccessful authentication using the first mode;
provide a security notice to a security system responsive to the first and second modes of authentication being unsuccessful,
wherein the presentation of the self-service GUI on the display device is responsive to a successful authentication.

13. The apparatus of claim 12, wherein the first mode of authentication comprises a fingerprint analysis, and wherein the second mode of authentication comprises one of voice or facial recognition.

14. A non-transitory computer-readable storage medium comprising computer instructions that, when executed by at least one processor, cause the at least one processor to:
receive a request for scheduling of a user via a user interface of an electronic terminal;
obtain scheduling options responsive to the received request, wherein the scheduling options are determined based on scheduling information, wherein the scheduling information comprises employment schedule data for other users that are associated with the user;
present the scheduling options on a display device of the electronic terminal;
receive a scheduling selection from among the scheduling options that is inputted via the user interface;
determine an availability of a supervisor associated with the user; and
initiate a video conference for obtaining a scheduling determination when the supervisor is determined to be available, wherein the video conference utilizes the user interface and the display device of the electronic terminal.

15. The non-transitory computer-readable storage medium of claim 14, wherein the scheduling information further comprises at least one of a work load associated with the user, a work load associated with one or more of the other users, a work efficiency associated with the user, a work efficiency associated with one or more of the other users, a skill set associated with the user, or a skill set associated with one or more of the other users.

16. The non-transitory computer-readable storage medium of claim 14, comprising computer instructions that, when executed by the at least one processor, cause the at least one processor to:
provide the scheduling selection to a remote server for evaluation;
receive a human resources approval from the remote server; and
store the scheduling selection in a memory accessible by the electronic terminal when the supervisor is determined to be unavailable.

17. The non-transitory computer-readable storage medium of claim 16, comprising computer instructions that, when executed by the at least one processor, cause the at least one processor to:
terminate access to the electronic terminal for the user;
receive the scheduling determination;
store the scheduling determination in the memory;
monitor for subsequent access of the electronic terminal by the user; and
provide the scheduling determination on the display device responsive to the user subsequently accessing the electronic terminal.

18. The non-transitory computer-readable storage medium of claim 14, comprising computer instructions that, when executed by the at least one processor, cause the at least one processor to:
receive a speech input via the user interface from the user, wherein speech recognition is utilized to generate text representative of the speech input, wherein the text is parsed and wherein a determination is made whether the text includes the request for scheduling.

19. The non-transitory computer-readable storage medium of claim 14, comprising computer instructions that, when executed by the at least one processor, cause the at least one processor to:
provide the scheduling selection to a remote server for evaluation;
receive a human resources approval from the remote server;
provide a printed confirmation of the human resources approval;
capture an image of the printed confirmation having an indicia from the supervisor, wherein the indicia represents a scheduling determination by the supervisor; and
provide a determination message to the remote server responsive to capturing the image.

20. A server, comprising:
a memory; and
a controller circuit coupled to the memory, wherein the controller circuit is programmed to:
communicate over a network with a group of electronic terminals at remote locations;
receive a request for scheduling from an electronic terminal of the group of electronic terminals, wherein the request was generated at the electronic terminal via a user input of a user;
access scheduling information associated with the user, wherein the scheduling information comprises employment schedule data for other users that are associated with the user;
determine scheduling options based on the scheduling information;
provide the scheduling options to the electronic terminal for presentation to the user;
receive a scheduling selection from among the scheduling options, wherein the scheduling selection was generated at the electronic terminal via another user input of the user; and
adjust the scheduling information based on the scheduling selection prior to receiving a scheduling determination of a supervisor associated with the user.

21. The server of claim 20, wherein the scheduling information further comprises at least one of a work load associated with the user, a work load associated with one or more of the other users, a work efficiency associated with the user, a work efficiency associated with one or more of the other users, a skill set associated with the user or a skill set associated with one or more of the other users.

22. The server of claim 20, wherein the controller circuit is programmed to:
obtain an evaluation of the scheduling selection; and
provide a human resources approval to the electronic terminal based on the evaluation.

23. The server of claim 20, wherein the request for scheduling comprises one or more requested paid time off days inputted at the electronic terminal by the user, wherein the controller circuit is programmed to determine the scheduling options based in part on the one or more requested paid time off days, and wherein the scheduling options comprise one or more alternative paid time off days that are different from the one or more requested paid time off days.

24. A method comprising:
receiving a request for scheduling of a first user via a user interface of an electronic terminal;
obtaining scheduling options responsive to the received request, wherein the scheduling options are determined based on scheduling information, wherein the scheduling information comprises employment schedule data for other users that are associated with the first user;
presenting the scheduling options on a display device of the electronic terminal;
receiving a scheduling selection from among the scheduling options that is inputted via the user interface;
monitoring for access to the electronic terminal by a second user of the other users; and
providing a message on the display device responsive to the second user accessing the electronic terminal, wherein the message is based on the inputted scheduling selection, and wherein the message represents a query to exchange a portion of schedules associated with the first and second users.
